(19) United States
(12) Patent Application Publication
(10) Pub. No.: US 2017/0116602 A1
(43) Pub. Date: Apr. 27, 2017

(54) BIOMETRIC VERIFICATION SYSTEMS AND METHODS FOR PAYMENT TRANSACTIONS

(71) Applicant: MasterCard International Incorporated, Purchase, NY (US)

(72) Inventor: Rohit CHAUHAN, Somers, NY (US)

(21) Appl. No.: 14/921,284

(22) Filed: Oct. 23, 2015

(51) Int. Cl. G06Q 20/38; G06Q 20/20; G06Q 20/40

(52) U.S. Cl. CPC G06Q 20/3829; G06Q 20/40145; G06Q 20/4012; G06Q 20/206

(57) ABSTRACT

According to some embodiments, a point of sale device may read a user's biometric information. The point of sale device may then execute an encryption algorithm on the biometric information read to create a token key value. The point of sale device may also receive a personal identification number value from the user and transmit the token key value and the personal identification number value to an authentication server. The authentication server may determine that the received token key value and the personal identification number value match a verified token key value and a verified personal identification number value in a registered user database. The authentication server may then transmit a signal to the point of sale device indicating that the received token key value and the personal identification number value match the verified token key value and the verified personal identification number value in the registered user database.

### BACKGROUND

People use payment accounts to facilitate transactions. For example, in some cases an account owner may insert a payment card (e.g., a credit card or debit card) into an Automated Teller Machine (“ATM”), enter his or her Personal Identification Number (“PIN”), and receive cash that he or she can then use to purchase items or services. In other cases, an account owner may present his or her payment card at a merchant Point Of Sale (“POS”) device (e.g., at a merchant's cash register) to purchase items and/or services.

Note that using a payment card at an ATM or merchant POS device may be inconvenient for an account owner, such as an account owner who does not want to carry a wallet or purse. Moreover, a person other than the account owner may come into possession of the payment card (or even just a credit card number) and attempt to make a transaction using the owner's account (e.g., when the payment card is lost or stolen). Attempting to verify that a person is actually an account holder, can be an expensive, time-consuming, and error prone task for a merchant or online retailer (e.g., who may ask a person to enter a PIN and/or to present additional identification, such as a state issued driver's license). This can be especially true when a substantial number of people (perhaps associated with many different card issuers) attempt a substantial number of transactions in many different locations.

In some cases, a party may attempt to use biometric information to verify a person's identity. For example, a bank or other party involved in payment transaction might maintain a large database containing user fingerprints. A user might scan his or her fingerprint at an ATM or merchant POS device which would in turn transmit an image of the fingerprint to the bank or other party. The image of the fingerprint could then be verified and the transaction authorized. Note, however, that many people will feel uncomfortable having private information, such as fingerprint images, stored by a bank or similar entity. Moreover, if the fingerprint image information was somehow intercepted by an unauthorized party between the ATM or merchant POS device and the bank, the potential for misuse and fraud is substantial.

It would therefore be desirable to provide accurate and efficient systems and methods to identify an account owner when he or she attempts to make a transaction using a payment account.

### BRIEF DESCRIPTION OF THE DRAWINGS

FIG. 1 is a block diagram overview of a system according to some embodiments of the present invention.

FIG. 2 illustrates a point of sale device method that might be performed in accordance with some embodiments.

FIG. 3 illustrates an authentication platform method that might be performed in accordance with some embodiments.

FIG. 4 is a block diagram overview of a system according to some embodiments of the present invention.

FIG. 5 is block diagram of an authentication tool or platform according to some embodiments of the present invention.

FIG. 6 is a tabular portion of a registered user database according to some embodiments.

FIG. 7 illustrates a smartphone biometric payment verification registration display according to some embodiments.

FIG. 8 illustrates a biometric payment verification account portal display that might be provided in accordance with some embodiments.

### DETAILED DESCRIPTION

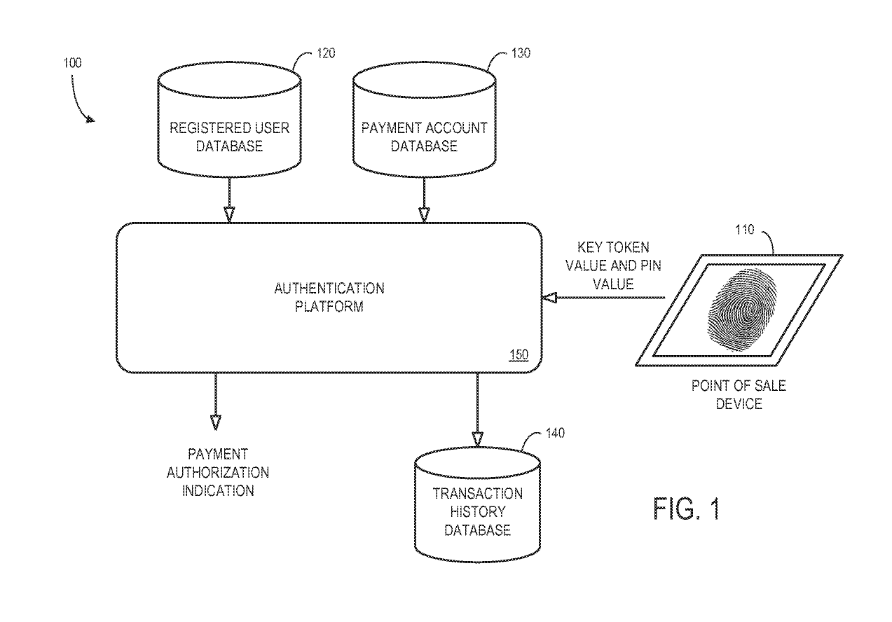

In some cases an account owner may insert a payment card (e.g., a credit card or debit card) into an ATM, enter his or her PIN, and receive cash that he or she can then use to purchase items or services. In other cases, an account owner may present his or her payment card at a merchant POS device to purchase items or services. Note that using a payment card at a POS device may be inconvenient for some account owners. It would therefore be desirable to provide accurate and efficient systems and methods to identify an account owner when he or she attempts to make a transaction using a payment account. FIG. 1 is block diagram of a system 100 according to some embodiments of the present invention. In particular, the system 100 includes an authentication platform 150 that receives information from a merchant POS or ATM device 110.

The authentication platform 150 might be, for example, associated with a Personal Computer (“PC”), laptop computer, an enterprise server, a server farm, and/or a database or similar storage devices. The authentication platform 150 may, according to some embodiments, be associated with a credit card company.

According to some embodiments, an “automated” authentication platform 150 may identify an account owner when he or she attempts to make a transaction using a payment account. For example, the authentication platform 150 may automatically output a payment authorization indication to the POS device or to any other party (e.g., a credit card issuer). As used herein, the term “automated” may refer to, for example, actions that can be performed with little (or no) intervention by a human.

As used herein, devices, including those associated with the authentication platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN, and/or an Internet Protocol (“IP”) network such as the Internet, an intranet, or an extranet. Note that any devices described herein may communicate via one or more such communication networks.

The authentication platform 150 may retrieve data from a registered user database 120 and/or a payment account database 130. The payment account database 130 might be associated with, for example, payment accounts, such as credit card or bank accounts. The registered user database 120 and the payment account database 130 may be locally stored or reside remote from the authentication platform 150. As will be described further below, the registered user database 120 and payment account database 130 may be used by the authentication platform 150 to generate a payment authorization message. According to some embodiments, the authentication platform 150 communicates information to an external device, such as by transmitting an electronic file to an email server, a workflow management system, POS device, etc. In other embodiments, the authentication platform 150 might store transaction information in a transaction history database 170. Note that, according to some embodiments, the registered user database 120 does not store any biometric information. Instead, the registered user database 120 may store token key values (created based on biometric information) and/or PIN values. Moreover, it might not be possible to re-create biometric information using the stored token key values.

Although a single authentication platform 150 is shown in FIG. 1, any number of such devices may be included. Moreover, various devices described herein might be combined according to embodiments of the present invention. For example, in some embodiments, the authentication platform 150, registered user database 120 and/or payment account database 130 might be co-located and/or may comprise a single apparatus.

In accordance with some embodiments, the systems and methods described herein provide a framework to identify people who attempt to make ATM and/or merchant POS transactions based on biometric information (that is not stored or transmitted over a network) and information associated with payment accounts. By way of example, and without limiting the generality of the foregoing, a payment card can be a credit card, debit card, charge card, stored-value card, or prepaid card or nearly any other type of financial transaction card. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an ATM, an online sale, a sale complete via a television, or any other suitable institution or device configured to initiate a financial transaction per the request of the account owner.

The information in the payment account database 130 may be associated with, for example, a “payment card processing system” or “credit card processing networks,” such as the MasterCard® network that allows account owners to use payment cards issued by a variety of issuers to shop at a variety of merchants. With this type of payment card, a card issuer or attribute provider, such as a bank, extends credit to an account owner to purchase products or services. When an account owner makes a purchase from an approved merchant, or withdraws funds via an ATM, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases or cash withdrawals, generally on a monthly basis.

The payment account database 130 may further store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group. According to some embodiments, different business classifications may be associated with different biometric standards.

The payment account database 130 may also store a “merchant category code” or “MCC,” which is a four-digit number created by MasterCard® or VISA® and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, MCCs are used by card issuers to categorize, track or restrict certain types of purchases. According to some embodiments, different MCCs may be associated with different biometric standards.

In accordance with some embodiments, data associated with payment card transactions is stored within the transaction history database 140. The data may include, for example, a listing of sales amount for each payment card transaction including the type of goods and/or services sold, a total number of goods and/or services sold in each transaction, a total sales amount for each transaction (e.g., gross dollar amount), a token keys value received from the account owner, etc. In addition, for each merchant and/or business, the data associated with each transaction may include a point-of-sale or point-of-purchase (e.g., location of each payment card transaction). The point-of-sale or point-of-purchase provides that for merchants and/or businesses having one or more locations, the location of the merchant and/or business, which generated the sale can be identified.

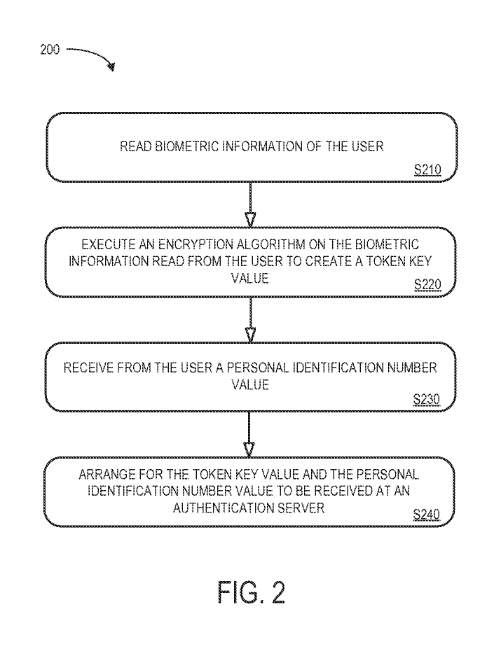

FIG. 2 illustrates a POS device method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a POS device may read biometric information of the user. As used herein, the term “POS device” may refer to a merchant POS device, an ATM device, an online transaction (where, for example, a computer mouse may be adapted to read a user's fingerprint, a television transaction (where, for example, a television remote control may be adapted to read a user's fingerprint), etc. Moreover, according to some embodiments, the biometric user data comprises fingerprint information. Note that the ridges of a human finger are detailed, unique, difficult to alter, and durable over the life of an individual—which make them suitable as a long-term marker of human identity. Fingerprint identification, known as dactyloscopy, is the process of comparing two instances of ridge skin patterns to determine whether the impressions came from the same individual. Because no two finger or palm prints are ever exactly alike in every detail, an expert or computer system may use threshold scoring rules to determine whether two ridge patterns are likely to have originated from the same finger. Note, however, that embodiments described herein do not employ dactyloscopy. According to some embodiments, the biometric information comprises a plurality of fingerprints of the user (e.g., all five fingers of the person's left hand).

Note that embodiments may be associated with biometric data other than fingerprints. For example, the biometric user data might be associated with “palm vein biometrics.” Note that the pattern of blood veins in person's palm is unique to every individual (even among identical twins). Moreover, palms have a broad, complicated vascular pattern and thus contain a wealth of differentiating features for personal identification. Furthermore, these patterns will not vary during a person's lifetime. As a result, it is a very secure method of authentication because this blood vein pattern lies under the skin (making it difficult for others to read or copy).

An individual's vein pattern image might be captured by having sensors in a touchscreen radiate the person's hand with near-infrared rays. The reflection method illuminates the palm using an infrared ray and captures the light given off by the region after diffusion through the palm. The deoxidized hemoglobin in the in the vein vessels absorb the infrared ray, thereby reducing the reflection rate and causing the veins to appear as a black pattern. This vein pattern may then be captured. As veins are internal in the body and have a wealth of differentiating features, attempts to forge an identity are extremely difficult, thereby enabling a high level of security. In addition, the sensors of a palm vein device might only recognize the pattern when the deoxidized hemoglobin is actively flowing within the individual's veins. Note that such a sensor is not dangerous; a near infrared is a component of sunlight (there is no more exposure when scanning a hand as compared to walking outside in the sun). Further note that palm veins are inside the hand, and are therefore protected and less susceptible to minor trauma, cuts, etc. (as compared to some fingerprint systems). Also, the sensors may be contactless, hygienic, non-invasive, and highly accurate (e.g., with a false rejection rate of 0.01% and false acceptance rate of 0.00008%).

Other examples of biometric information that might be associated with embodiments described herein include facial information, retina information, DNA information, palm print data, hand geometry information, iris recognition data, and voice data.

At S220, the POS device may execute an encryption algorithm on the biometric information read from the user to create a token key value. The token key value may comprise, for example, a sixteen or twenty digit number that is uniquely generated based on the person's fingerprint (or other biometric data). Note that the encryption algorithm may be executed such that the original biometric information read from the user cannot be determined from the token key value. At S230, the POS device may receive from the user a PIN value. For example, he or she might enter a 4-digit PIN value using a keypad or touch screen at a merchant's POS device. Note that the token key value might comprise an alpha-numeric series associated with a tokenization algorithm (e.g., a series of 16 digits, 20 digits, etc.).

At S240, the POS device may arrange for the token key value and the PIN value to be received at an authentication server. For example, the POS device might transmit the token key value and PIN value to the authentication server without including any biometric information. In this way, people may feel more comfortable using the system and the chance of having private information stolen or otherwise compromised may be reduced.

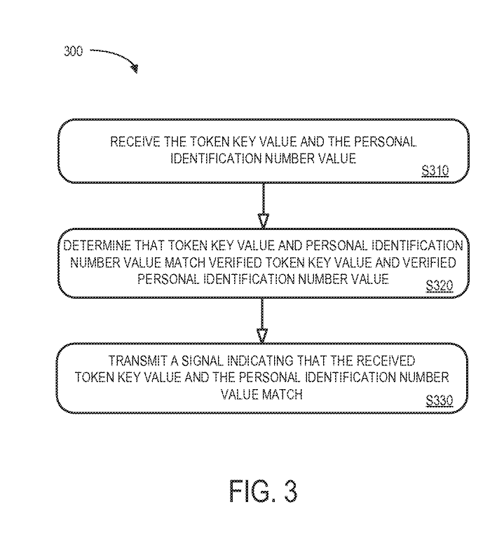

FIG. 3 illustrates an authentication server method that may be performed by some or all of the devices described with respect to the system 100 of FIG. 1. At S310, an authentication server may receive a token key value and a PIN value. For example, the authentication server might receive a transaction authentication message, from a POS device, that includes this information (within receiving any biometric information of the user).

At S320, the authentication server may determine that the received token key value and the PIN value match a verified token key value and a verified PIN value in a registered user database. For example, according to some embodiments the authentication server is coupled to a registered user database that stores, for each of a plurality of registered users, a verified token key value and an associated verified PIN value. In this case, the authentication server may search the registered user database to determine if it contains the token key value received in a transaction authentication message.

At S330, the authentication server may transmit a signal indicating that the received token key value and the PIN value match the verified token key value and the verified PIN value in the registered user database. That is, the authentication server may approve the transaction when it is determined that the user's token key value and PIN value match what is in the registered user database.

According to some embodiments, prior to using the system a user is registered with the authentication server, including the establishment and storage of the verified token key value and the associated verified PIN value in connection with a payment account. The payment account might be associated with, for example, a credit card account, a debit card account, an electronic wallet (e.g., associated with multiple payment accounts), and/or a pre-paid payment account. According to some embodiments, this establishment may be performed via a smartphone application executing on the user's smartphone. The smartphone application may, for example, generate a token key value in the same way a POS terminal would perform that function. Note that a smartphone is used herein only as an example, and embodiments may be associated with any other device able to capture biometric data.

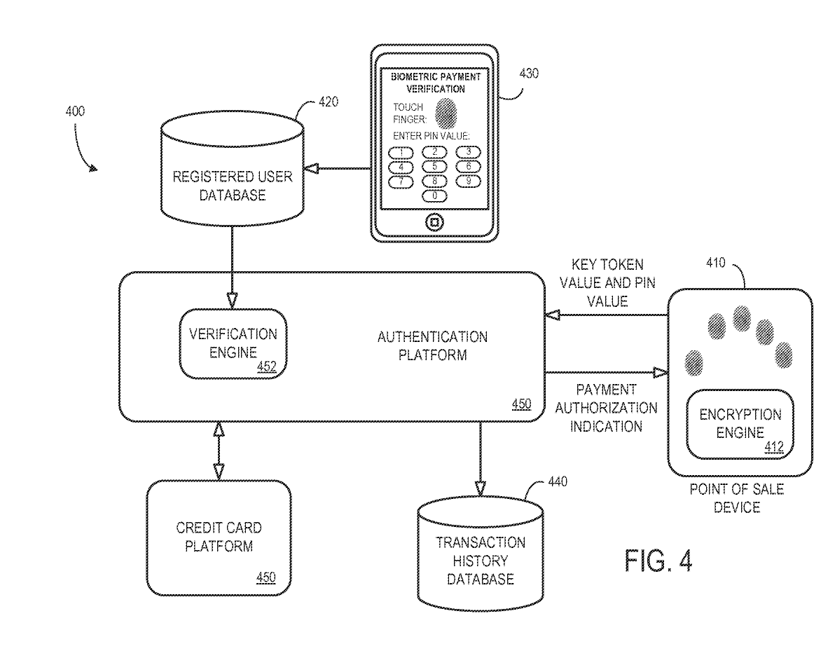

FIG. 4 is block diagram of a system 400 according to some embodiments of the present invention. As before, the system 400 includes an authentication platform 450 that receives information from a merchant POS or ATM device 410. In particular, the POS device 410 may include an encryption engine that automatically generates key token value based on a user's fingerprint. The authentication platform 450 might be, for example, associated with a PC, laptop computer, an enterprise server, a server farm, and/or a database or similar storage devices. The authentication platform 450 may, according to some embodiments, be associated with a credit card company and/or communicate with a credit card platform 450.

According to some embodiments, an automated authentication platform 450 may identify an account owner when he or she attempts to make a transaction using a payment account. For example, the authentication platform 450 may automatically output a payment authorization indication to the POS device 410 or to any other party (e.g., a credit card issuer).

As used herein, devices, including those associated with the authentication platform 450 and any other device described herein, may exchange information via any communication network which may be one or more of a LAN, a MAN, a WAN, a proprietary network, a PSTN, a WAP network, a Bluetooth network, a wireless LAN, and/or an IP network such as the Internet, an intranet, or an extranet. Note that any devices described herein may communicate via one or more such communication networks.

A verification engine 452 of the authentication platform 450 may retrieve data from a registered user database 420 and/or a payment account database. The payment account database might be associated with, for example, payment accounts, such as credit card or bank accounts. The registered user database 420 and the payment account database may be locally stored or reside remote from the authentication platform 450. As will be described further below, the registered user database 420 and payment account database may be used by the authentication platform 450 to generate a payment authorization message. Information in the registered user database 420 might, according to some embodiments, be received from a user's smartphone during a registration process. According to some embodiments, the authentication platform 450 might store transaction information in a transaction history database 470. Note that, according to some embodiments, the registered user database 420 does not store any biometric information. Instead, the registered user database 420 may store token key values (created based on biometric information) and/or PIN values. Moreover, it might not be possible to re-create biometric information using the stored token key values.

Although a single authentication platform 450 is shown in FIG. 4, any number of such devices may be included. Moreover, various devices described herein might be combined according to embodiments of the present invention.

In accordance with some embodiments, the systems and methods described herein provide a framework to identify people who attempt to make ATM and/or merchant POS transactions based on biometric information (that is not stored or transmitted over a network) and information associated with payment accounts. By way of example, and without limiting the generality of the foregoing, a payment card can be a credit card, debit card, charge card, stored-value card, or prepaid card or nearly any other type of financial transaction card. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an ATM, an online sale, a sale complete via a television, or any other suitable institution or device configured to initiate a financial transaction per the request of the account owner.

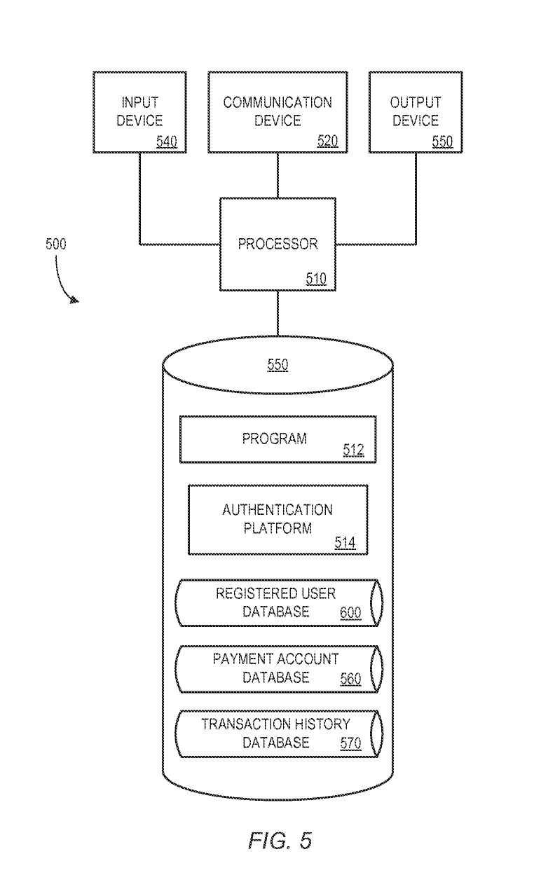

In this way, the authentication platform may collect and store information about a substantial number of users with actually collecting biometric information (or even information that could be used to re-create biometric user information). Note that the embodiments described herein may be implemented using any number of different hardware configurations. For example, FIG. 5 illustrates an authentication platform 500 that may be, for example, some or all of the elements associated with the systems 100, 400 of FIGS. 1 and 4. The authentication platform 500 comprises a processor 510, such as one or more commercially available Central Processing Units (“CPUs”) in the form of one-chip microprocessors, coupled to a communication device 520 configured to communicate via a communication network (not shown in FIG. 5). The communication device 520 may be used to communicate, for example, with one or more ATM or merchant POS devices. The authentication platform 500 further includes an input device 540 (e.g., a computer mouse and/or keyboard to enter information about user accounts) and an output device 550 (e.g., a computer monitor or printer to output registered user or transaction reports).

The processor 510 also communicates with a storage device 530. The storage device 530 may comprise any appropriate information storage device, including combinations of magnetic storage devices (e.g., a hard disk drive), optical storage devices, mobile telephones, and/or semiconductor memory devices. The storage device 530 stores a program 512 and/or authentication platform logic 514 for controlling the processor 510. The processor 510 performs instructions of the programs 512, 514, and thereby operates in accordance with any of the embodiments described herein. For example, a POS device may read a user's biometric information. The POS device may then execute an encryption algorithm on the biometric information read to create a token key value. The POS device may also receive a personal identification number value from the user and transmit the token key value and the personal identification number value to the processor 510. The processor 510 may determine that the received token key value and the personal identification number value match a verified token key value and a verified personal identification number value in a registered user database. The processor 510 may then transmit a signal to the POS device indicating that the received token key value and the personal identification number value match the verified token key value and the verified personal identification number value in the registered user database.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the authentication platform 500 from another device; or (ii) a software application or module within the authentication platform 500 from another software application, module, or any other source.

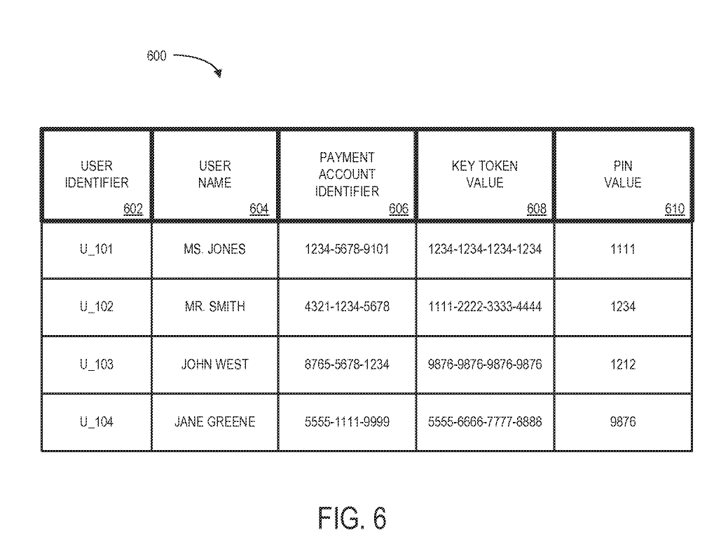

In some embodiments (such as shown in FIG. 5), the storage device 530 further stores a registered user database 600, a payment account database 560, and a transaction history database 570. One example of a database that may be used in connection with the authentication platform 500 will now be described in detail with respect to FIG. 6. Note that the database described herein is only an example, and additional and/or different information may actually be stored therein. Moreover, various databases might be split or combined in accordance with any of the embodiments described herein. For example, the registered user database 600 and/or the payment account database 560 might be combined, co-located, and/or linked to each other within the authentication platform 500.

Referring to FIG. 6, a table is shown that represents the registered user database 600 that may be stored at the authentication platform 500 according to some embodiments. The table may include, for example, entries identifying account owners who may want to make transactions via a payment account (e.g., credit card transactions). The table may also define fields 602, 604, 606, 608, 610 for each of the entries. The fields 602, 604, 606, 608, 610 may, according to some embodiments, specify: a user identifier 602, a user name 604, a payment account identifier 606, a key token value 608, and a PIN value 610. The registered user database 600 may be created and updated, for example, based on information electrically received during a registration processes and/or as user's use their payment accounts.

The user identifier 602 may be, for example, a unique alphanumeric code identifying an account owner and the user name 604 might comprise his or her legal name. The payment account 606 might comprise a credit card number, such as a Primary Account Number (“PAN”) associated with a that user's payment account (e.g., credit card account, debit card account, etc.). The key token value 608 may comprise, for example, a sixteen or twenty digit number generated by an encryption algorithm using the user's biometric information (e.g., his or her fingerprint). Note that it might not be possible to re-create the user's biometric information from the key token value 608. The PIN value might comprise, for example, a 4-digit number selected by the user or by an authentication platform.

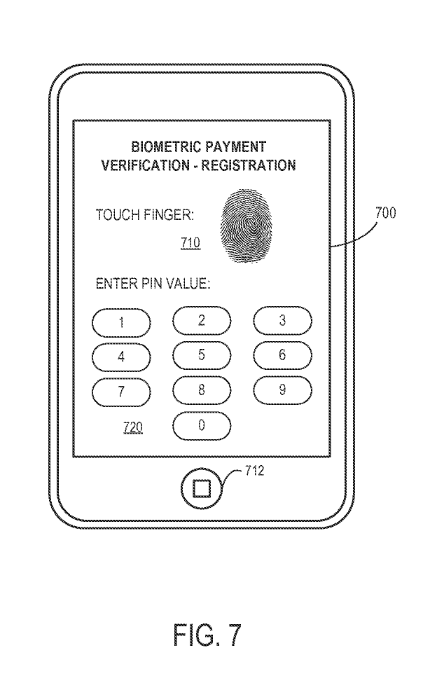

FIG. 7 illustrates a smartphone biometric payment verification registration display 700 according to some embodiments. The display 700 might, for example, run on the user's smartphone when he or she registers with an authentication system. The display 700 includes a first area 710 a user can touch with his or her finger to provide fingerprint information (assuming the smartphone touchscreen supports such a feature). According to other embodiments, a separate scanner 712 might be provided on the smartphone for this purpose. An application running on the smartphone may then execute an encryption process to automatically generate a token key value (which could then be transmitted to a remote authentication server or registered user database for storage and later use during an authentication process). The display may further include a second area 720 including a keypad that can be used by the user to define a PIN value for his or her biometric verification account.

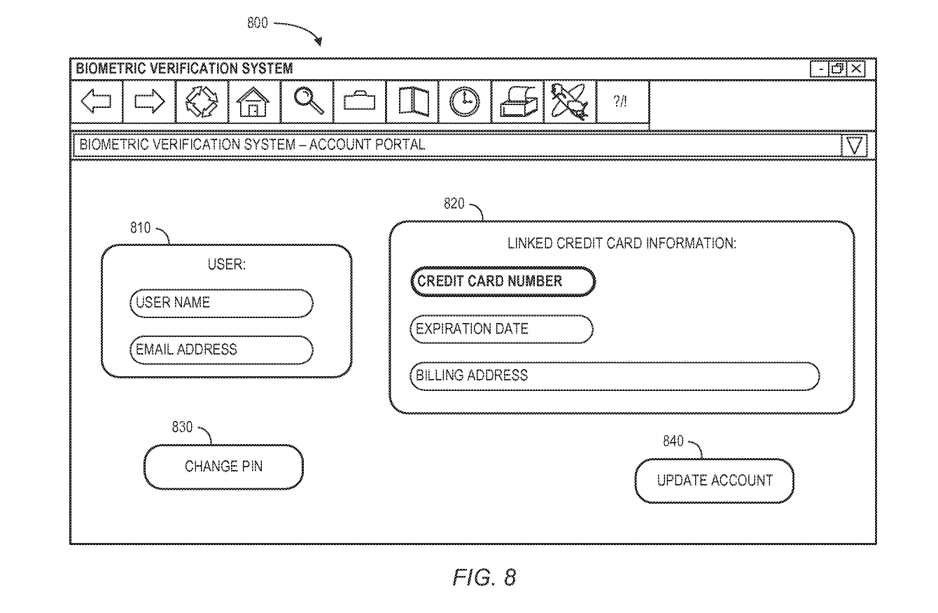

FIG. 8 illustrates a biometric payment verification account portal display 800 that might be performed in accordance with some embodiments. The portal display 800 may include, for example, a first area 810 where a user may define or alter a name associated with a biometric verification system, an email address associated with the biometric verification system, etc. The portal display 800 may further include a second area 820 where a user may define or alter one or more payment accounts associated with the biometric (e.g., a credit card number, expiration date, billing address, etc.). Selection of a “Change Pin” icon 830 may let the user define a 4-digit PIN value to be associated with his or her account. Selection of an “Update Account” icon 840 may apply these changes to his or her account.

Thus, according to some embodiments, an improved authentication platform might automatically approve transactions even when no payment card is present during an ATM, merchant POS, or other type of transaction. In addition, people may feel more comfortable knowing that their personal biometric information is not being stored or transmitted over a network (where it might be inappropriately accessed by unauthorized parties). Moreover, any embodiments described herein might be implemented for any type of transaction, including online transactions, television transactions (e.g., biometric information might be collected as the user is entering his or her PIN into a remote control unit and then automatically converted to a token key value before being sent to an authentication platform), etc. The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system to verify a user's identify in connection with a payment transaction, comprising:
(a) a point of sale device programmed to:
(i) read biometric information of the user,
(ii) execute an encryption algorithm on the biometric information read from the user to create a token key value,
(iii) receive from the user a personal identification number value, and
(iv) arrange for the token key value and the personal identification number value to be received at an authentication server;
(b) a registered user database storing, for each of a plurality of registered users, a verified token key value and an associated verified personal identification number value; and
(c) an authentication server, coupled to the registered user database, programmed to:
(v) receive the token key value and the personal identification number value,
(vi) determine that the received token key value and the personal identification number value match a verified token key value and a verified personal identification number value in the registered user database, and
(vii) transmit a signal indicating that the received token key value and the personal identification number value match the verified token key value and the verified personal identification number value in the registered user database.

2. The system of claim 1, wherein the biometric information comprises a fingerprint of the user and the point of sale device comprises at least one of a merchant point of sale device and an automated teller machine device.

3. The system of claim 1, wherein the biometric information comprises a plurality of fingerprints of the user.

4. The system of claim 1, wherein the encryption algorithm is executed such that the biometric information read from the user cannot be determined from the token key value.

5. The system of claim 1, wherein the personal identification number value comprises 4 digits and the token key value comprises an alpha-numeric series associated with a tokenization algorithm.

6. The system of claim 1, wherein the biometric information comprises at least one of: facial information, retina information, DNA information, palm print data, hand geometry information, iris recognition data, and voice data.

7. The system of claim 1, wherein the point of sale device is associated with at least one of: (i) a touchscreen, (ii) a computer mouse, and (iii) a television controller.

8. The system of claim 1, wherein, prior to said receiving, the user is registered with the authentication server, including the establishment and storage of the verified token key value and the associated verified personal identification number value in connection with a payment account.

9. The system of claim 8, wherein the payment account is associated with at least one of: (i) a credit card account, (ii) a debit card account, (iii) an electronic wallet, and (iv) a pre-paid payment account.

10. The system of claim 8, wherein said establishment is performed via a smartphone application or any other device able to capture biometric data.

11. A computer-implemented method, comprising:
reading, by a point of sale device, biometric information of the user;
executing, by the point of sale device, an encryption algorithm on the biometric information read from the user to create a token key value;
receiving, by the point of sale device from the user, a personal identification number value;
transmitting the token key value and the personal identification number value from the point of sale device to an authentication server;
receiving the token key value and the personal identification number value at the authentication server;
determining that the received token key value and the personal identification number value match a verified token key value and a verified personal identification number value in a registered user database; and
transmitting a signal, from the authentication server to the point of sale device, indicating that the received token key value and the personal identification number value match the verified token key value and the verified personal identification number value in the registered user database.

12. The method of claim 11, wherein the biometric information comprises a fingerprint of the user and the point of sale device comprises at least one of a merchant point of sale device and an automated teller machine device.

13. The method of claim 11, wherein the biometric information comprises a plurality of fingerprints of the user.

14. The method of claim 11, wherein the encryption algorithm is executed such that the biometric information read from the user cannot be determined from the token key value.

15. The method of claim 11, wherein the personal identification number value comprises 4 digits and the token key value comprises an alpha-numeric series associated with a tokenization algorithm.

16. The method of claim 11, wherein the biometric information comprises at least one of: facial information, retina information, DNA information, palm print data, hand geometry information, iris recognition data, and voice data.

17. The method of claim 11, wherein the point of sale device is associated with at least one of: (i) a touchscreen, (ii) a computer mouse, and (iii) a television controller.

18. The method of claim 11, wherein, prior to said receiving, the user is registered with the authentication server, including the establishment and storage of the verified token key value and the associated verified personal identification number value in connection with a payment account.

19. The method of claim 18, wherein the payment account is associated with at least one of: (i) a credit card account, (ii) a debit card account, (iii) an electronic wallet, and (iv) a pre-paid payment account.

20. The method of claim 18, wherein said establishment is performed via a smartphone application or any other device able to capture biometric data.
